(19) United States
(12) Patent Application Publication
(10) Pub. No.: US 2011/0264737 A1
(43) Pub. Date: Oct. 27, 2011

(54) Systems and Methods for Defining User Relationships in a Social Networking Environment

(76) Inventor: James Skinner, Singapore (SG)

(21) Appl. No.: 12/766,583

(22) Filed: Apr. 23, 2010

(51) Int. Cl. G06F 15/16; G06F 17/30

(52) U.S. Cl. 709/204; 707/802; 707/E17.044

(57) ABSTRACT

Systems and methods automatically define relationships in a social networking environment. A discussion thread of a social networking environment is monitored for comments. When a comment is received to the discussion thread from a first user of the social networking environment, a relationship of the social networking environment is automatically defined between the first user and a second user associated with the discussion thread based on the receipt of the first comment from the first user. The automatically-defined relationship information is used to format news feeds with updates regarding activities taken in the social networking environment by related users.

### BACKGROUND OF THE INVENTION

1. Field of the Invention

The present invention relates to systems and methods for defining user relationships, and more particularly to systems and methods for automatically defining such relationships in the context of a social networking environment based on participation in common discussion thread or other shared social networking activity.

2. Background and Related Art

Many Internet sites, such as Facebook, Mixi, and MobJet provide systems and methods for providing relationships (such as “friend” relationships) among users in a social networking environment. These sites use a variety of different mechanisms for providing the relationships between users.

In one typical configuration, users may search for other users of the site using a search function, a browse function, or through the site recommending users who may be of interest to the user accessing the site. The user then requests that a “friend” relationship be established. The request is formatted and transmitted to the other user. If approval of the request is received from the other user, then a “friend” relationship is established, and the relationship is stored in the database. This relationship may be used to format various news feeds or notifications of activity of the related user or to allow access to certain information, which may be restricted to users with whom such a relationship exists. In some instances, a relationship may also be presumed to exist between the user and friends of friends.

In another common configuration, users may search for other users of interest using a search function, a browse function, or through the site recommending users who may be of interest to the user accessing the site, as with the previous example. The user then requests to “follow” the other user. This request may be dependent upon approval of the other user or may be automatically approved. The “follower” relationship is then stored in the database. This relationship may be used to format various news feeds or notifications of activity of the related user or to allow access to certain information, which may be restricted to users with whom such a relationship exists.

In another common configuration, users may search for other users of interest using a search function, a browse function, or through the site recommending users who may be of interest to the user accessing the site, as with the other examples. The user may then indicate that the other user is a “favorite.” This “favorite” relationship is then stored in the database. This relationship may be used to format various news feeds or notifications of activity of the related user or to allow access to certain information, which may be restricted to users with whom such a relationship exists.

In another configuration, users may search for “groups” of users of interest using a search function, a browse function, or through the site recommending users who may be of interest to the user accessing the site. The user may then request to join the “group.” This request may be dependent upon approval of some other user (such as a group moderator or member) or may be automatically approved. Upon approval or upon request, the user is then added to a list of users who are members of that group. This relationship may be used to format various news feeds or notifications of activity of the group or to allow access to certain information, which may be restricted to users with whom such a relationship exists.

### BRIEF SUMMARY OF THE INVENTION

Implementation of the invention may occur in conjunction with a variety of computer and network environments that may be used to support or provide a social networking environment. One implementation provides a method for automatically defining a relationship in a social networking environment. The method includes monitoring a discussion thread of a social networking environment for comments, receiving a first comment to the discussion thread from a first user of the social networking environment, and automatically defining a relationship of the social networking environment between the first user and a second user associated with the discussion thread based at least on the receipt of the first comment from the first user.

Implementation of the invention may provide an alternative method for automatically defining a relationship in a social networking environment. This method includes monitoring a discussion thread of a social networking environment for comments, receiving a first comment to the discussion thread from a first user of the social networking environment, receiving a second comment to the discussion thread from a second user of the social networking environment, automatically defining a relationship of the social networking environment between the first user and the second user at least in part based on both users having commented on a same discussion thread, and storing the relationship in a database of relationships for use by the social networking environment to provide notifications of activity in the social networking environment between the first and second users. The relationship may also or alternatively be used by the system to provide access to information that is restricted to users having such a relationship.

Implementation of the invention includes computer and network systems configured to facilitate the various methods defined by the various implementations of the invention. In addition, implementation of the invention embraces the use of various non-transitory computer-readable media storing computer instructions to implement the methods defined by the various implementations of the invention.

### BRIEF DESCRIPTION OF THE SEVERAL VIEWS OF THE DRAWINGS

The objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described and explained with additional specificity and detail through the use of the accompanying drawings in which:

FIG. 1 shows a representative computer system for use in conjunction with embodiments of the invention;

FIG. 2 shows a representative network environment for use in conjunction with embodiments of the invention;

FIG. 3 shows a representative screen shot that may be displayed in association with certain embodiments of the invention;

FIG. 4 shows a representative screen shot that may be displayed in association with certain embodiments of the invention; and

FIG. 5 shows a flow chart illustrating aspects of various embodiments of the invention.

### DETAILED DESCRIPTION OF THE INVENTION

A description of embodiments of the present invention will now be given with reference to the Figures. It is expected that the present invention may take many other forms and shapes, hence the following disclosure is intended to be illustrative and not limiting, and the scope of the invention should be determined by reference to the appended claims.

Embodiments of the invention may occur in conjunction with a variety of computer and network environments that may be used to support or provide a social networking environment. As such, embodiments of the invention include computer and network systems configured to facilitate the various methods defined by the various embodiments of the invention described herein as well as variants thereof, even if not specifically described herein. In addition, embodiments of the invention embrace the use of various non-transitory computer-readable media storing computer instructions to implement the methods defined by the various embodiments of the invention, as described in more detail below.

Certain embodiments include a method for automatically defining a relationship in a social networking environment. The method includes monitoring a discussion thread of a social networking environment for comments, receiving a first comment to the discussion thread from a first user of the social networking environment, and automatically defining a relationship of the social networking environment between the first user and a second user associated with the discussion thread based at least on the receipt of the first comment from the first user. The definition and/or creation of the relationship may be additionally based on a variety of additional factors, as discussed in more detail below.

A discussion thread, as discussed herein, includes any of a variety of interactive social networking tools in which one or more users of a social networking environment may post or otherwise provide comments that may be viewed or otherwise accessed by other users and where other users may also post comments for viewing or access by others. The term “discussion thread” as used herein is also intended to embrace all uses of the term currently understood with respect to social networking environments. In the context of a social networking environment having such discussion threads, “comments” may include one or more of text, an image, audio, a document, video, hyperlink data, executable code, and combinations and/or multiples thereof.

In certain embodiments, the method further includes storing information regarding the relationship in a database associated with the social networking environment. Whether the relationship is stored in a database or not, defining the relationship may include evaluating whether the relationship should be defined and determining a strength of the defined relationship. This evaluation and determination may include determinations based on at least one of: a number of discussion threads associated in common with each of the first and second users, a number of times the first and second users have commented in one or more same discussion threads, a time proximity between participation of the first user in a particular discussion thread and participation of the second user in the particular discussion thread, a number of intervening comments between participation of the first user in a selected discussion thread and participation of the second user in the selected discussion thread, a number of users making comments between participation of the first user in a selected discussion thread and participation of the second user in the selected discussion thread, demographic data regarding the first and second users, other relationship data of the first and second users, a minimum threshold of participation of the first and second users in shared discussion threads, a relationship filter requested by one of the first user and the second user, and existing relationships with other users shared by both the first and second users.

In certain embodiments, modifications of a strength and/or maintenance of the relationship over time may occur. For example, modifications may be based on continued participation of the first and second users in at least one of the original discussion thread and other discussion threads.

In certain embodiments, the method includes additional features such as suggesting the relationship to one of the first user and the second user, requesting approval of one of the first user and the second user to define the relationship, and/or receiving approval of the relationship from at least one of the users.

When the relationship is established, certain embodiments of the method include features of using the relationship to format a news feed regarding activities of the social networking environment; and delivering the news feed to one of the first user and the second user. The news feed may be formatted according to and contain information pertaining to a plurality of relationships of the user receiving the news feed.

Additionally, in certain embodiments, one of the creation of the news feed, the transmission of the news feed, the display of the news feed, and the inclusion of information in the news feed can be modified based on a variety of factors. A non-limiting list of such factors includes a time since a last prior notification to the user receiving the news feed, a time since a last comment of the first user and the second user in a shared discussion thread, a number of discussion threads associated in common with each of the first and second users, a number of users who share a relationship with the user receiving the news feed and who have commented on a discussion thread being notified, a number of times the first and second users have commented in one or more same discussion threads, a time proximity between participation of the first user in a particular discussion thread and participation of the second user in the particular discussion thread, a number of intervening comments between participation of the first user in a selected discussion thread and participation of the second user in the selected discussion thread and/or in other related or unrelated discussion threads, a number of users making comments between participation of the first user in a selected discussion thread and participation of the second user in the selected discussion thread, shared times of activity in the social networking environment, demographic data regarding the first and second users, other relationship data of the first and second users, a minimum threshold of participation of the first and second users in shared discussion threads, a relationship filter requested by one of the first user and the second user, criteria established by the user receiving the news feed, and existing relationships with other users shared by both the first and second users.

The news feed may be transmitted or provided to the user receiving the news feed using one of a user interface associated with the social networking environment, and a notification sent externally to the social networking environment, such as an e-mail, instant message, or other external message. In some embodiments a display is formatted and provided to the first user of one or more discussion threads in which the second user has participated, and may form a part of a notification.

In some embodiments of the method at least one of the first user and the second user is notified of the automatic definition of the relationship. The user so notified may also be notified of one of site usage information regarding the other user and online status information regarding the other user.

Some embodiments of the invention may provide an alternative method for automatically defining a relationship in a social networking environment. This method includes monitoring a discussion thread of a social networking environment for comments, receiving a first comment to the discussion thread from a first user of the social networking environment, receiving a second comment to the discussion thread from a second user of the social networking environment, automatically defining a relationship of the social networking environment between the first user and the second user at least in part based on both users having commented on a same discussion thread, and storing the relationship in a database of relationships for use by the social networking environment to provide notifications of activity in the social networking environment between the first and second users. The relationship may also or alternatively be used by the system to provide access to information that is restricted to users having such a relationship.

In certain instances, a strength of the relationship is modified based on at least one of a number of discussion threads the first user and the second user have commented on, a number of comments made by the first and second users in shared discussion threads, a number of times the first user and the second user have participated in a same discussion thread, a time proximity between comments in a same thread by the first user and the second user, a number of intervening comments between the first comment and the second comment, a number of users making comments between the first comment and the second comment, preferences from one of the first user and the second user regarding the relationship, a number of shared relationships between each of the first user and the second user and other users, demographic data regarding the first and second users, an amount of time that has passed since a last comment by the first and second users in a shared discussion thread, a total number of existing relationships between one of the first user and the second user and additional users other than the first user and the second user, a strength of one or more existing relationships between one of the first user and the second user and additional users other than the first user and the second user, an amount of time since a last activity in the social networking environment of the first and second users, and/or any combination thereof.

News feeds transmitted to other users in accordance with embodiments of the invention may include a notification of a posting by the second user of one of a new discussion thread, a comment on an existing discussion thread, user-identifying information associated with the other user, information regarding a number of discussion threads in which the first and second users have both participated, information regarding a strength of the relationship, information regarding an existence of the relationship, information regarding a number of users with whom the receiving user has a relationship, information regarding one of a name and a topic of a discussion thread being notified, and a list of actions that may be taken in response to information contained within the news feed.

In some instances, one or more of the creation, transmission, and display of the news feed is modified based on at least one of a number of times users have participated in one or more same discussion threads, a number of comments related users have made in common discussion threads, an amount of time that has passed since a last prior notification to the first user, demographic data, existence of other relationships, an amount of time since the relationship was formed, an amount of time since the relationship was strengthened, a strength of the relationship, geographic data regarding the first and second users, a number of users having relationships with the receiving user who are participating in a particular discussion thread, and/or any combination thereof.

In some instances, the system formats and displays a list of users for each user showing with whom the user has established relationships. When this is done, the list of users may be formatted based on at least one of a strength of the established relationship between the receiving user and each user in the list, a date of most recent activity for each user in the list, demographic data regarding each user in the list, the existence of other relationship information between the receiving user and the users in the list, geographic data, activity data regarding the users in the list, and/or any combination thereof.

Because a very large number of users may end up being related, the system may weight or filter the relationship and or the news feeds with various users, particularly based on the number of times such users have talked with each other or the volume of activity on such occasions.

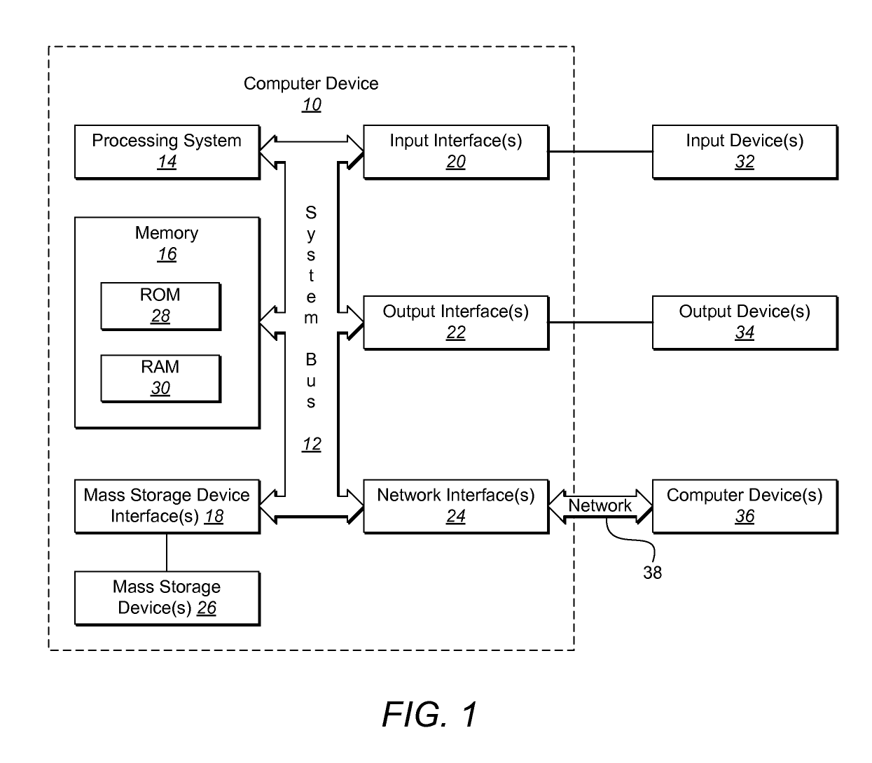

As it is anticipated that embodiments of the invention utilize various computer and network configurations, FIG. 1 and the corresponding discussion are intended to provide a general description of a suitable operating environment in which embodiments of the invention may be implemented. One skilled in the art will appreciate that embodiments of the invention may be practiced by one or more computing devices and in a variety of system configurations, including in a networked configuration. However, while the methods and processes of the present invention have proven to be particularly useful in association with a system comprising a general purpose computer, embodiments of the present invention include utilization of the methods and processes in a variety of environments, including embedded systems with general purpose processing units, digital/media signal processors (DSP/MSP), application specific integrated circuits (ASIC), stand alone electronic devices, and other such electronic environments.

Embodiments of the present invention embrace one or more computer-readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer-readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system.

Embodiments of the invention also embrace the use of distributed computer-readable media as well as novel computer-readable media as such may be invented. With the increasing prevalence of cloud computing, computer instructions for executing various methods may not be stored in a single computer-readable medium at a single location. Instead, various computer-readable media distributed across a plurality of devices (such as network-connected servers, client devices, and the like) may store portions of computer instructions necessary to complete a particular method. The use of such distributed computer-readable media and cloud computing is embraced by embodiments of the invention. If, in the future, different schemes for providing computer-readable media are discovered or invented, embodiments of the invention embrace the use of such media. For example, research continues into the use of holographic memory and biologic memory. If such efforts prove fruitful, it is anticipated that such media could be advantageously used with embodiments of the invention.

While embodiments of the invention embrace the use of all types of computer-readable media, certain embodiments as recited in the claims may be limited to the use of tangible, and/or non-transitory computer-readable media, and the phrases “tangible computer-readable medium” and “non-transitory computer-readable medium” (or plural variations) used herein are intended to exclude transitory propagating signals per se.

With reference to FIG. 1, a representative system for implementing embodiments of the invention includes computer device 10, which may be a general-purpose or special-purpose computer or any of a variety of consumer electronic devices. For example, computer device 10 may be a personal computer, a notebook computer, a netbook, a personal digital assistant (“PDA”) or other hand-held device, a workstation, a minicomputer, a mainframe, a supercomputer, a multi-processor system, a network computer, a processor-based consumer electronic device, or the like.

Computer device 10 includes system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below.

Processing system 14 includes one or more processors, such as a central processor and optionally one or more other processors designed to perform a particular function or task. It is typically processing system 14 that executes the instructions provided on computer-readable media, such as on memory 16, a magnetic hard disk, a removable magnetic disk, a magnetic cassette, an optical disk, or from a communication connection, which may also be viewed as a computer-readable medium.

Memory 16 includes one or more computer-readable media that may be configured to include or includes thereon data or instructions for manipulating data, and may be accessed by processing system 14 through system bus 12. Memory 16 may include, for example, ROM 28, used to permanently store information, and/or RAM 30, used to temporarily store information. ROM 28 may include a basic input/output system (“BIOS”) having one or more routines that are used to establish communication, such as during start-up of computer device 10. RAM 30 may include one or more program modules, such as one or more operating systems, application programs, and/or program data.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include hard disk drives, magnetic disk drives, tape drives and optical disk drives. A mass storage device 26 may read from and/or write to a magnetic hard disk, a removable magnetic disk, a magnetic cassette, an optical disk, or another computer-readable medium. Mass storage devices 26 and their corresponding computer-readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 20 may be employed to enable a user to enter data and/or instructions to computer device 10 through one or more corresponding input devices 32. Examples of such input devices include a keyboard and alternate input devices, such as a mouse, trackball, light pen, stylus, or other pointing device, a microphone, a joystick, a game pad, a satellite dish, a scanner, a camcorder, a digital camera, and the like. Similarly, examples of input interfaces 20 that may be used to connect the input devices 32 to the system bus 12 include a serial port, a parallel port, a game port, a universal serial bus (“USB”), an integrated circuit, a firewire (IEEE 1394), or another interface. For example, in some embodiments input interface 20 includes an application specific integrated circuit (ASIC) that is designed for a particular application. In a further embodiment, the ASIC is embedded and connects existing circuit building blocks.

One or more output interfaces 22 may be employed to connect one or more corresponding output devices 34 to system bus 12. Examples of output devices include a monitor or display screen, a speaker, a printer, a multi-functional peripheral, and the like. A particular output device 34 may be integrated with or peripheral to computer device 10. Examples of output interfaces include a video adapter, an audio adapter, a parallel port, and the like.

One or more network interfaces 24 enable computer device 10 to exchange information with one or more other local or remote computer devices, illustrated as computer devices 36, via a network 38 that may include hardwired and/or wireless links. Examples of network interfaces include a network adapter for connection to a local area network (“LAN”) or a modem, wireless link, or other adapter for connection to a wide area network (“WAN”), such as the Internet. The network interface 24 may be incorporated with or peripheral to computer device 10. In a networked system, accessible program modules or portions thereof may be stored in a remote memory storage device. Furthermore, in a networked system computer device 10 may participate in a distributed computing environment, where functions or tasks are performed by a plurality of networked computer devices.

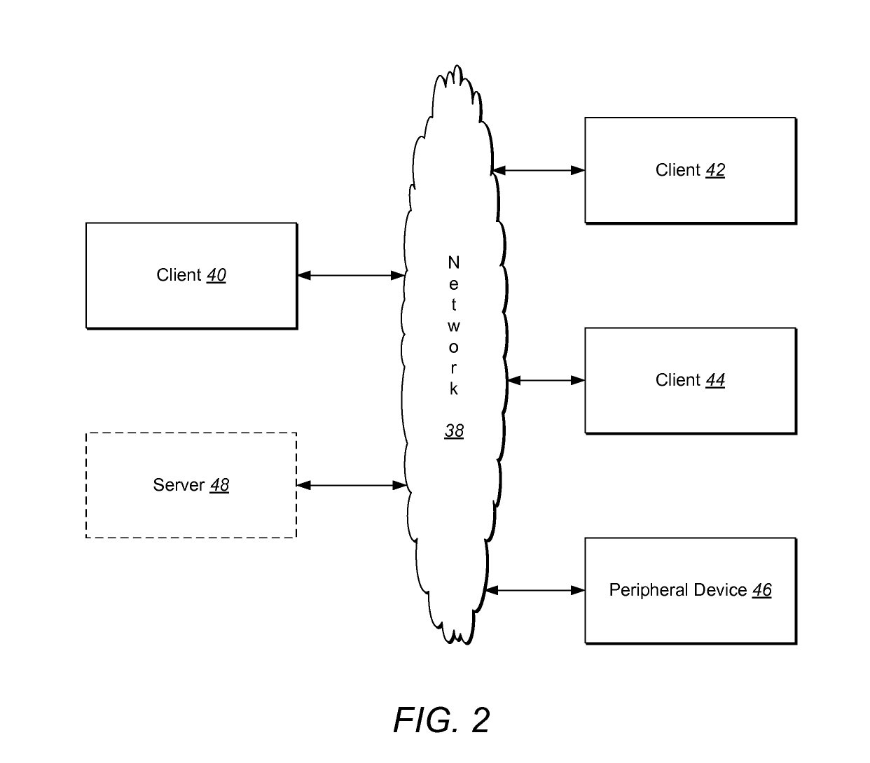

Thus, while those skilled in the art will appreciate that embodiments of the present invention may be practiced in a variety of different environments with many types of system configurations, FIG. 2 provides a representative networked system configuration that may be used in association with embodiments of the present invention. The representative system of FIG. 2 includes a computer device, illustrated as client 40, which is connected to one or more other computer devices (illustrated as client 42 and client 44) and one or more peripheral devices 46 across network 38. While FIG. 2 illustrates an embodiment that includes a client 40, two additional clients, client 42 and client 44, one peripheral device 46, and optionally a server 48, connected to network 38, alternative embodiments include more or fewer clients, more than one peripheral device, no peripheral devices, no server 48, and/or more than one server 48 connected to network 38. Other embodiments of the present invention include local, networked, or peer-to-peer environments where one or more computer devices may be connected to one or more local or remote peripheral devices. Moreover, embodiments in accordance with the present invention also embrace a single electronic consumer device, wireless networked environments, and/or wide area networked environments, such as the Internet.

Within a computer and/or network environment such as those described with respect to FIGS. 1 and 2, systems and methods are provided for automatically defining a user relationship in a social networking environment based on whether users have participated in a common comment or discussion thread (“discussion thread” or simply “thread”). The system displays discussion threads that users can comment on. Each discussion thread may be started in a variety of ways, including by the system, by system administrators, or by individual users of the system. Comments added to the threads may include textual, image, audio, document, video, hyperlink data, and/or executable code elements. The individual users may search for, browse, or otherwise find the discussion threads and can add comments as desired.

In at least some embodiments, when a first user adds a comment to a thread, the system automatically establishes a relationship between the first user and a second user associated with the thread. The second user may be the originator of the thread, or the second user may be at least one other user who has commented in the thread. In at least some embodiments, multiple relationships may be simultaneously established. In other words, the system may automatically establish relationships between the first user and more than one other user associated with the thread. Additionally, one or more additional relationships with the first user may be automatically established with additional users who comment on the thread after the first user's comment. Any relationships so established may be stored in a database of relationships associated with the system, which may be implemented across one or more network-connected devices such as servers, server clusters, and the like.

Thus, the system allows for the automatic definition of a user relationship in a social networking environment based on user participation in a comment thread. This occurs without the first user or any other user needing to request the establishment of a relationship, unlike as required in previous social networking environments.

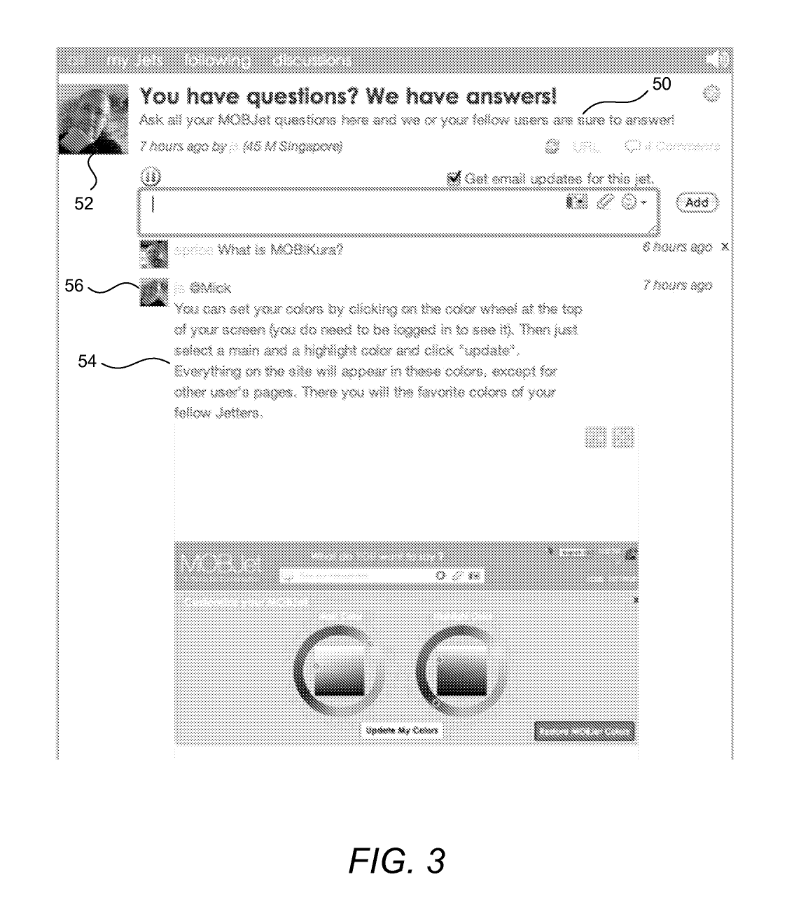

FIG. 3 shows a representative screen shot showing a discussion thread as it might be shown in a browser or other viewing software over a network such as the Internet. The illustrated discussion thread might have been initiated by a first comment 50, which was posted by a user 52. The thread then continued with a second comment 54 posted by a user 56, and so forth. When the user 56 posts the second comment 54, the system of one embodiment establishes one or more relationships, such as with the user 52. For example, the system may presume that a relationship such as a “chat mate” relationship should exist between the user 52 and the user 56 because the users have participated in a common discussion thread. This relationship is useful in a social networking context, as it is indicative of common interests and of familiarity between the users, as user 56 will have been likely to have recognized the name, image, or comments made by user 52 in the shared thread.

From a social networking perspective, defining relationships in this way is particularly appealing, because the user does not need to take action regarding the creation of their social network, but may merely comment on threads of interest, and have their social graph or social network automatically generated for them by the system.

In some embodiments, not all relationships that are established are established with equal strength. Instead, some evaluation may occur to determine a strength of the relationship at the time it is established. If a strength of the relationship does not exceed some threshold, the system may determine not to establish or store the relationship at all. A variety of factors may be used to determine the strength of a potential relationship. As one example, a number of discussion threads associated in common with each of the users of the relationship. Thus, if both users have commented in threads A, B, and C, the strength of the relationship may be stronger than if one of the two users has commented in thread A only. This factor takes into account that if the users are both commenting in multiple threads, their interests coincide and they are more likely to have become aware of each other.

As another example, the system may evaluate a number of times that each user has commented in a particular shared discussion thread. Thus, if both users have commented in thread A, and one user has commented four times in that thread and the other user has commented three times in that thread, the strength of the relationship may be stronger than if both users had only commented in that thread a single time each. This factor reflects that the users are more likely to have become aware of the other user's comments where more comments exist in the thread.

The strength of the relationship may also be stronger if the two users' comments are in close proximity within a particular thread. Proximity may refer to time proximity and/or comment proximity and intervening comments or the number of users participating in the discussion thread between the comments of the related users. Thus, if the users both commented within a short period of time of each other on a particular thread, or if there are no intervening comments or users (or just a few intervening comments or users) between the comments of the two users, the system may determine that the relationship should be stronger than if the users commented at times greatly separated by time or intervening comments. When users comment in close proximity, they are more likely to have become aware of the other's comments, and additionally, they are more likely to be available to access the system at similar times for future interactions.

The strength of the relationship may also be varied based on a variety of demographic factors. Such factors may be input by the users as part of a registration process, may be determined by the system based on certain usage patterns, or may be determined in any other fashion known in the art. Non-limiting examples of demographic data include age of the users, sex of the users, relationship status of the users (e.g. married, single, committed relationship, etc.), location of the users, and the like. Thus, for example, the system may determine that the strength of the relationship will be stronger between a single male user in his twenties and a single female user in her twenties than between a single female user in her twenties and a married male user in his sixties. Alternatively, if a user has an interest in establishing relationships with users of dissimilar demographic data, and has notified the system of that preference, the comparative strength of the relationships described in this paragraph might be reversed.

Another example of a factor that may be used to determine a strength of the relationship and/or whether a relationship should be formed and stored in the system is other relationship data of the two users. As one example, if both users have many other strong relationships, the system might determine that it would be best not to establish a new relationship in an instance of a single interaction between the users. Alternatively, if both users are new and have few relationships in the system, then the system might favor formation of a new relationship and/or might increase the strength of the formed relationship. As another example, if the system determines that the users have multiple relationships with other users in common, it may strengthen the relationship in comparison to a situation where the users have no relationships with other users in common.

In other instances, the system may utilize a minimum threshold of participation of the two users in determining whether a relationship is formed between them. Thus, if both users made a single short comment in a single discussion thread, no relationship might be formed, or the formed relationship might be weak. Alternatively, if both users commented extensively in a shared discussion thread, such as alternating comments (e.g. had a discussion) in a particular thread, the relationship may be determined to be stronger.

In some embodiments, the system may take into account certain preferences of the users when forming relationships. Thus, the users could provide relationship filters that favor formation of and strengthening of certain relationships and that disfavor formation of other relationships. Such filters may be based on any of the factors discussed herein or other factors not specifically discussed herein. As one example, one user's filter may indicate not to form relationships with any users when intervening comments are found between the users' comments. As another example, a user may request a gradual disfavoring of relationships with users as the dissimilarity between their respective time zones increases. These are merely examples of types of filters or preferences that might be established by certain users, and it will be appreciated that the number of filters and combinations thereof that might be established is essentially limitless.

Still another example of a factor that may be used in determining the strength of a relationship is the amount of time that has passed since a last activity by one of the users in the discussion thread and/or the social networking environment. In some instances, a significant amount of time (days, weeks, or more) may pass between adjoining comments on a particular discussion thread. Additionally, some users may be relatively inactive in the social networking environment. Thus, if a user comments in a discussion thread that has had no prior comments for some time, the system may evaluate whether a relationship should be formed (and the strength thereof) even between the last two commenting users. As an example, if both users are fairly active in the social networking environment, the system may still determine to form a relationship based on their shared interest in the discussion thread, even though they participated in the thread at widely separated times. If, however, one or both users has been less active recently, the system may elect not to form a relationship, or to form a weaker relationship.

Determining a strength of a relationship at the time of relationship formation is merely one example of how relationships may be strengthened or weakened by the system. In at least some embodiments, the system modifies a strength of the various relationships and whether various relationships should be maintained in the system over time. The system may do so using any of the various factors discussed herein, such as continued participation of the users in the original discussion thread that was the source of the relationship or participation in other discussion threads in common. As another example, the system may strengthen relationships where users take actions related to notifications associated with the relationship, as will be discussed in more detail below.

While embodiments of the invention provide for automatic creation and maintenance of relationships between users, certain embodiments of the invention provide users with an opportunity to approve or disapprove of formation of the relationship. In some embodiments, this may occur for all users and all relationships, and in other embodiments, obtaining approval of the relationship may be limited to certain users, such as users who request to approve their relationships. Where approval is to be obtained, the system may suggest the relationship to one or both of the users. The system then requests that the user approve the relationship. When the system receives approval of the relationship, it defines it as discussed herein and stores the approved relationship in its database.

In some instances and in certain types of social networking environments, it may be desirable to permit a unidirectional relationship (e.g. a follower-type relationship) to exist. Thus, in some embodiments, a relationship may be formed between two users even if one of the users does not wish or need to obtain any benefits of the relationship or even if one user disapproves the relationship. If this occurs, the relationship may effectively exist for one user of the pair, and not for the other; one user may then receive notifications relating to the other user's activities as discussed below, while the other user may not receive notifications of the first user's activities. Use of this unidirectional-type relationship may also be desirable between users having greatly-different amounts of relationships: the user having a great number of relationships may be less interested in updates of the other user, while the user having fewer relationships may be more interested in updates regarding the first user.

Embodiments of the invention utilize the existence of the relationship to enhance the users' social networking experience. One way this is accomplished is in the delivery of notifications and news feeds to users regarding the activities of other users with whom they have relationships. Another way this is accomplished is by providing access to information that may be restricted to users having such a relationship. Thus, the system uses the relationship to format a news feed for a user regarding activities of the social networking environment and delivers the news feed to the user. The news feed may be formatted to and contain information and notifications pertaining to a plurality of relationships of the user receiving the news feed. The news feed may be delivered to the user in a variety of fashions, such as within a user interface associated with the social networking environment and alternatively or additionally by way of a notification sent externally to the social networking environment, such as an e-mail, instant message, text message, short messaging service (SMS) message, and the like.

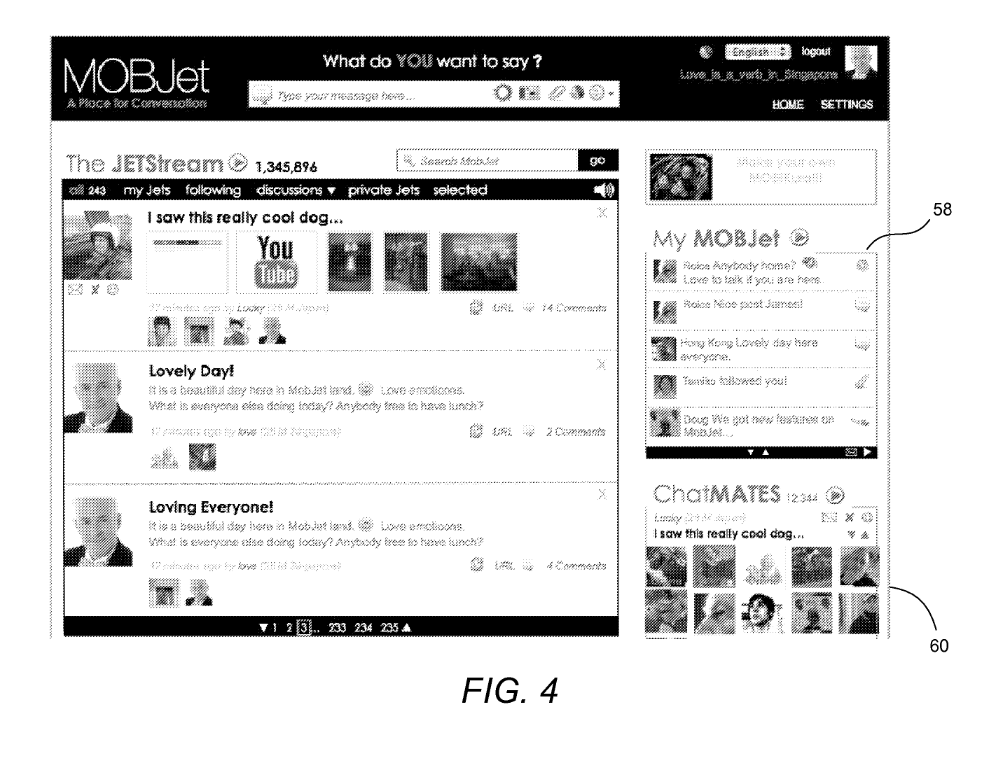

FIG. 4 shows a representative screen shot that shows ways in which a news feed may be formatted and delivered to a user. In FIG. 4, the screen shot is a screen shot from within the social networking environment, and therefore displays a view that might be seen in a user's browser window. A news feed may be displayed in a variety of ways and may include a variety of information, and the manners specifically illustrated in FIG. 4 are therefore intended to be illustrative only. In FIG. 4, screen area 58 on the right side of the screen shot shows one way in which a news feed may be formatted. Similarly, screen area 60 on the lower right side shows another way in which a news feed may be formatted.

In screen area 58, various notification items are shown. In this embodiment, each notification item includes a picture or image associated with and identifying the user associated with that notification. Each notification item also includes a user name associated with that notification. Each notification item includes a brief textual element that notifies the user of the content of the item (e.g. comment in a discussion thread) being notified. Additionally, the notification item may include one or more icons that may convey additional information about the content associated with the notification item. For example, one icon may indicate that a new discussion thread has been started. Another icon may indicate that a certain type of file is associated with a comment (e.g. a video file, an audio file, an image, etc.). Other icons may represent the online or offline status of the person associated with the notification item. A wide variety of other icons may be used in the notifications.

In screen area 60, a more minimized and streamlined view is provided. In this format, only an image associated with each user is displayed, as well as an online or offline status identifier superimposed on some or all of the images. Each image thus serves as a notification item in this example. In this way, information regarding a greater number of users may be displayed.

Regardless of the amount of information displayed and the type or types of news feed display used, additional information (such as a display of one or more discussion threads in which the user has recently participated) may be provided to the user upon taking certain types of actions. For example, additional information may be provided to the user upon clicking on or selecting a particular notification item or a portion thereof. Alternatively, additional information may be provided to the user when the user hovers over the notification item or a portion thereof. Further action beyond the action that provides additional information (e.g. an additional click, etc.) may take the user to an associated discussion thread or other location associated with the content being notified in the news feed. Similar information may be displayed in news feeds sent externally to the social networking environment.

The news feed may include a variety of information associated with the social networking environment. Non-limiting examples include a notification of a posting by other users of either a new discussion thread or a comment on an existing discussion thread. The news feed also may include user-identifying information regarding posting users, information regarding a number of discussion threads in which the receiving user and the posting users have both participated, information regarding a strength of the relationship between the receiving user and other users, information regarding the existence of relationships, information regarding a number of users with whom the receiving user has relationships, information regarding a name or topic of a discussion thread being notified, and a list of actions that may be taken in response to information contained within the news feed. Some of the information may be in the form of differing colors, sounds, sizes, placement, or text, and the information may be displayed initially or may be displayed based on actions taken by the user, such as clicking on an item or hovering a cursor over the item.

The creation of the news feed, the transmission/display of the news feed, and the inclusion of information in the news feed may be modified based on a variety of factors that are similar to the factors discussed above with respect to determining a strength of the relationship. Thus, the news feed and the information therein may be modified based on the strength of the user's various relationships, a number of discussion threads shared in common with various users, a number of users who share a relationship with the user receiving the news feed who have commented on a discussion thread being notified, a number of times the users have commented in one or more same discussion threads, geographic information regarding the users, a time proximity between participation of the user receiving the news feed and other users in a discussion thread, a discussion proximity (e.g. intervening comments) between participation of the user receiving the news feed and other users in a discussion thread, demographic data, other relationship data, a minimum threshold of participation, criteria and filters established by the user receiving the news feed, and the like.

Several additional factors may also be considered. For example, it may not be desirable to provide new notifications for each comment in a discussion thread when comments are being rapidly made. Thus, the system may take into account a time since a last prior notification to the user receiving the news feed when determining whether a new notification should be generated or transmitted. Therefore, a notification may be limited or restricted to the first time that a user comments in a given thread or to when a user comments in a given thread after a certain amount of time has elapsed since the last comment or notification. Similarly, the system may determine a last time that the receiving user or the other user participated in a shared discussion thread, and may limit notifications based on how much time has passed since the users have participated in shared discussions. When a threshold is used to limit or prevent too-rapid notifications, the threshold may be automatically adjusted based on the frequency of news feed notifications being formatted for transmission to a given user.

The news feed may be formatted to display a list of actions or to display such a list upon selection. The actions can include a variety of actions appropriate for the social networking environment, including to display a user's profile, display a conversation or thread being notified, comment on the conversation or thread being participated in by the related user, selecting to follow a related user, selecting to befriend a related user, opting to remove a user from future news feeds, opting to remove a conversation from future news feeds, and the like.

Any news item may contain the pertinent information directly, or may provide it indirectly, such as by showing a photo of the related user and making the remaining information available upon selecting that news item, such as by clicking with a pointing device or when a hover state is created with a pointing device. Any one of many methods of selection may be used to create this effect, such as clicking, double clicking, selection with arrow keys, touch screens, voice commands, or by use of technology to determine what part of the screen the user is looking at. FIG. 4 shows additional information being provided for a user selected in the news feed, which is configured to show the user photo. The user sees the photo and decides whether activity of that user is of present interest. Selecting the photo causes information on activity to be displayed, and may also cause the thread to be displayed or may present a link to the thread in which the activity being notified took place.

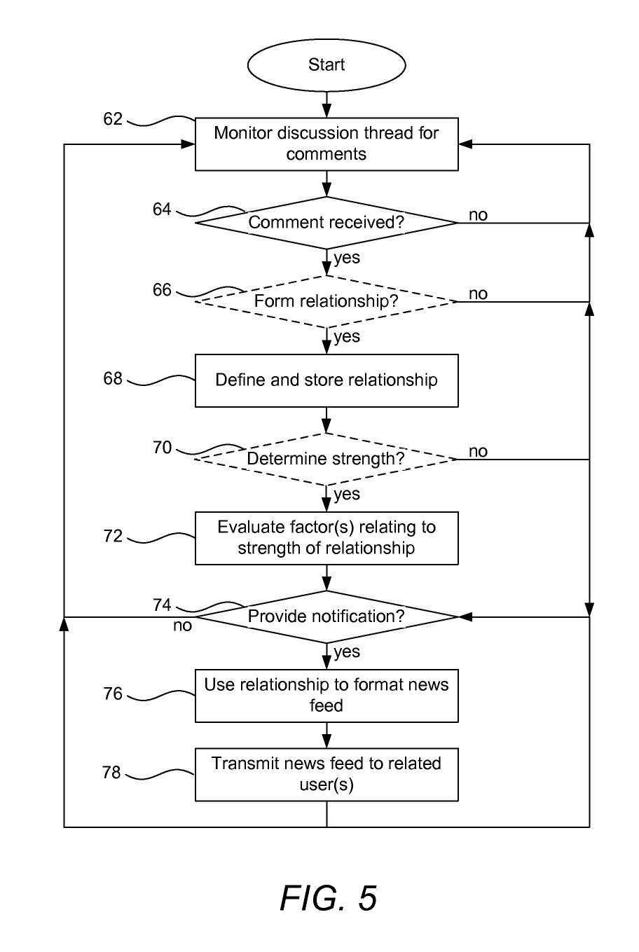

FIG. 5 shows a flow chart illustrating and summarizing features of certain embodiments of the invention that have been discussed in more detail above. FIG. 5 is provided to enhance understanding of certain features, and should not be considered limiting of the scope of the claimed invention. In FIG. 5, execution begins at step 62, where a discussion thread is monitored for comments. It should be understood that the system may simultaneously monitor large numbers of discussion threads, and that information collected from such monitoring may be utilized across the entire system. It should also be understood that certain aspects of the various embodiments may cause execution to begin at a step other than step 62, as required.

At some point, a user enters a comment into the monitored discussion thread, which is detected at decision block 64 where a determination is made as to whether a comment has been received. If not, execution loops back to step 62. If, however, a comment has been received, execution proceeds. In some embodiments, formation of a relationship occurs without a determination as to whether the relationship should be formed. In other embodiments, as illustrated by optional decision block 66, a determination is made as to whether to form or define a relationship. Any factors discussed herein, as well as other factors not specifically discussed herein may be used to determine whether or not to form a relationship for a user participating in the discussion thread.

If no relationship is to be formed, execution returns to decision block 62. When a relationship is to be formed or defined, execution proceeds to step 68, where the relationship is defined and stored in a database of the social networking environment system. Execution may continue to optional decision block 70, where a determination is made as to whether to evaluate a strength of the relationship, such as based on any or all of the factors discussed herein. If an evaluation of the strength of the relationship is to occur, execution proceeds to step 72 for this evaluation. While FIG. 5 shows steps 68 and 72 occurring in linear fashion, it should be understood that such steps may occur simultaneously, and that the system may repeatedly and/or continuously repeat such steps to modify the strength of the relationship, form a relationship at a later time, and/or remove a relationship, as a situation and evaluation may warrant.

Thus, even though FIG. 5 shows execution proceeding to decision block 74, it should be understood that FIG. 5 is merely illustrative of certain features, and is not intended to limit any embodiment to a linear process such as shown in FIG. 5. At decision block 74, a determination is made as to whether to provide a notification or news feed to one of the users in the relationship. Such determination may be made based on any factors discussed herein, or other relevant factors not specifically discussed herein. If no notification is to be made (for example, there is no status change or news worthy of providing a notification, a user that would receive the notification has enough other notifications that a notification related to the current relationship is not currently to be provided, etc.), execution loops back to step 62, or any of the other steps or decision blocks.

If, however, a notification is to be made, execution proceeds to step 76, where the system uses the relationship to format an appropriate news feed or notification, and then to step 78 where the news feed is transmitted to the appropriate related user or users. Execution then loops back to any of the other steps in the process for continued monitoring, evaluation, and notification as discussed herein.

The present invention may be embodied in other specific forms without departing from its spirit or essential characteristics. The described embodiments are to be considered in all respects only as illustrative and not restrictive. The scope of the invention is, therefore, indicated by the appended claims, rather than by the foregoing description. All changes which come within the meaning and range of equivalency of the claims are to be embraced within their scope.

What is claimed and desired to be secured by Letters Patent is:

1. A non-transitory computer-readable medium storing computer instructions for causing a computer to execute a method for automatically defining a relationship in a social networking environment, the method comprising:
monitoring a discussion thread of a social networking environment for comments;
receiving a first comment to the discussion thread from a first user of the social networking environment; and
automatically defining a relationship of the social networking environment between the first user and a second user associated with the discussion thread based at least on the receipt of the first comment from the first user.

2. A computer-readable medium as recited in claim 1, wherein the first comment comprises at least one of:
text;
an image;
audio;
a document;
video;
hyperlink data; and
executable code.

3. A computer-readable medium as recited in claim 1, wherein the method further comprises:
storing information regarding the relationship in a database associated with the social networking environment.

4. A computer-readable medium as recited in claim 1, wherein defining the relationship comprises:
evaluating whether the relationship should be defined and determining a strength of the defined relationship based on at least one of:
a number of discussion threads associated in common with each of the first and second users;
a number of times the first and second users have commented in one or more same discussion threads;
a time proximity between participation of the first user in a particular discussion thread and participation of the second user in the particular discussion thread;
a number of intervening comments between participation of the first user in a selected discussion thread and participation of the second user in the selected discussion thread;
a number of users making comments between participation of the first user in a certain discussion thread and participation of the second user in the certain discussion thread;
demographic data regarding the first and second users;
other relationship data of the first and second users;
a minimum threshold of participation of the first and second users in shared discussion threads;
a relationship filter requested by one of the first user and the second user; and
existing relationships with other users shared by both the first and second users.

5. A computer-readable medium as recited in claim 1, wherein the method further comprises:
modifying a strength and maintenance of the relationship over time based on continued participation of the first and second users in at least one of:
the original discussion thread; and
other discussion threads.

6. A computer-readable medium as recited in claim 1, wherein the method further comprises:
suggesting the relationship to one of the first user and the second user;
requesting approval of one of the first user and the second user to define the relationship;
receiving approval of the relationship; and
storing information regarding the relationship in a database associated with the social networking environment.

7. A computer-readable medium as recited in claim 1, wherein the method further comprises:
using the relationship to format a news feed regarding activities of the social networking environment; and
delivering the news feed to one of the first user and the second user.

8. A computer-readable medium as recited in claim 7, wherein the news feed is formatted according to and contains information pertaining to a plurality of relationships of the user receiving the news feed.

9. A computer-readable medium as recited in claim 7, wherein one of the creation of the news feed, the transmission of the news feed, the display of the news feed, and the inclusion of information in the news feed is modified based on one of:
a time since a last prior notification to the user receiving the news feed;
a time since a last comment of the first user and the second user in a shared discussion thread;
a number of discussion threads associated in common with each of the first and second users;
a number of users who share a relationship with the user receiving the news feed and who have commented on a discussion thread being notified;
a number of times the first and second users have commented in one or more same discussion threads;
a time proximity between participation of the first user in a particular discussion thread and participation of the second user in the particular discussion thread;
a number of intervening comments between participation of the first user in a selected discussion thread and participation of the second user in the selected discussion thread;
a number of users making comments between participation of the first user in a certain discussion thread and participation of the second user in the certain discussion thread;
demographic data regarding the first and second users;
other relationship data of the first and second users;
a minimum threshold of participation of the first and second users in shared discussion threads;
a relationship filter requested by one of the first user and the second user;
criteria established by the user receiving the news feed; and
existing relationships with other users shared by both the first and second users.

10. A computer-readable medium as recited in claim 7, wherein the news feed is transmitted to the user receiving the news feed using one of:
a user interface associated with the social networking environment; and
a notification sent externally to the social networking environment.

11. A computer-readable medium as recited in claim 1, wherein the method further comprises formatting a display to the first user of one or more discussion threads in which the second user has participated.

12. A computer-readable medium as recited in claim 1, wherein the method further comprises notifying at least one of the first user and the second user of the automatic definition of the relationship.

13. A computer-readable medium as recited in claim 12, wherein the method further comprises displaying, to the first user, one of site usage information regarding the second user and online status information regarding the second user.

14. A computer-readable medium as recited in claim 1, wherein automatically defining a relationship is further based on receipt of a second comment from the second user at a point in time selected from the group consisting of:
a time prior to receipt of the first comment; and
a time subsequent to receipt of the first comment.

15. A method for automatically defining a relationship in a social networking environment comprising:
monitoring a discussion thread of a social networking environment for comments;
receiving a first comment to the discussion thread from a first user of the social networking environment;
receiving a second comment to the discussion thread from a second user of the social networking environment;
automatically defining a relationship of the social networking environment between the first user and the second user at least in part based on both users having commented on a same discussion thread; and
storing the relationship in a database of relationships for use by the social networking environment to provide notifications of activity in the social networking environment between the first and second users.

16. A method as recited in claim 15, further comprising:
modifying a strength of the relationship based on at least one of:
a number of discussion threads the first user and the second user have commented on;
a number of comments made by the first and second users in shared discussion threads;
a number of times the first user and the second user have participated in a same discussion thread;
a time proximity between comments in a same thread by the first user and the second user;
a number of intervening comments between the first comment and the second comment;
a number of users making comments between the first comment and the second comment;
preferences from one of the first user and the second user regarding the relationship;
a number of shared relationships between each of the first user and the second user and other users;
demographic data regarding the first and second users;
an amount of time that has passed since a last comment by the first and second users in a shared discussion thread;
a total number of existing relationships between one of the first user and the second user and additional users other than the first user and the second user;
a strength of one or more existing relationships between one of the first user and the second user and additional users other than the first user and the second user; and
an amount of time since a last activity in the social networking environment of the first and second users.

17. A method as recited in claim 15, further comprising:
formatting a news feed including information regarding activities of the second user in the social networking environment; and
transmitting the news feed to the first user.

18. A method as recited in claim 17, wherein the news feed comprises at least one of:
a notification of a posting by the second user of one of a new discussion thread and a comment on an existing discussion thread;
user-identifying information associated with the second user;
information regarding a number of discussion threads in which the first and second users have both participated;
information regarding a strength of the relationship;
information regarding an existence of the relationship;
information regarding a number of users with whom the first user has a relationship;
information regarding one of a name and a topic of a discussion thread being notified; and
a list of actions that may be taken in response to information contained within the news feed.

19. A method as recited in claim 17, wherein one of the creation, transmission, and display of the news feed is modified based on at least one of:
a number of times users have participated in one or more same discussion threads;
a number of comments related users have made in common discussion threads;
an amount of time that has passed since a last prior notification to the first user;
demographic data;
existence of other relationships;
an amount of time since the relationship was formed;
an amount of time since the relationship was strengthened;
a strength of the relationship;
geographic data regarding the first and second users;
a number of users having relationships with the first user who are participating in a particular discussion thread; and
a combination thereof.

20. A method as recited in claim 15, further comprising formatting and displaying a list of users with whom the first user has established relationships.

21. A method as recited in claim 20, wherein the list of users is formatted based on at least one of:
a strength of the established relationship between the first user and each user in the list;
a date of most recent activity for each user in the list;
demographic data regarding each user in the list;
the existence of other relationship information between the first user and the users in the list;
geographic data; and
activity data regarding the users in the list.
